(19) United States
(12) Patent Application Publication
(10) Pub. No.: US 2026/0143330 A1
(43) Pub. Date: May 21, 2026

(54) SELF-GENERATION OF FULL FUNCTION ESIM PROFILE

(71) Applicant: Apple Inc., Cupertino, CA (US)

(72) Inventors: Jean-Marc PADOVA, San Francisco, CA (US); Li LI, Los Altos, CA (US); Abishek Kumar VAIDYANATHAN, Union City, CA (US); Viswanath NAGARAJAN, San Jose, CA (US); Aurelien P. RABOISSON, San Diego, CA (US); Ngabin S. NG, San Diego, CA (US)

(21) Appl. No.: 19/356,660

(22) Filed: Oct. 13, 2025

Related U.S. Application Data
(60) Provisional application No. 63/722,736, filed on Nov. 20, 2024.
(60) Provisional application No. 63/798,855, filed on May 2, 2025.

(51) Int. Cl. H04W 8/18; H04W 8/26; H04W 12/043

(52) U.S. Cl. CPC H04W 8/183; H04W 8/26; H04W 12/043

(57) ABSTRACT

Methods and apparatuses for self-generation of a full function electronic subscriber identity module (eSIM) profile for a wireless device by merging dynamically-provisioned credentials into an eSIM template that is specific or agnostic to a mobile network operator (MNO). When an MNO-specific eSIM template is available in the wireless device, the MNO-specific eSIM template is selected and provided to an embedded universal integrated circuit card (eUICC) of the wireless device. Alternatively, when the MNO-specific eSIM template is not available in the wireless device, an MNO-agnostic eSIM template is selected and provided to the eUICC. The dynamically-provisioned credentials are merged with the selected eSIM template to cause the eUICC to create a full function eSIM profile for the wireless device.

### CROSS-REFERENCE TO RELATED APPLICATIONS

The present application claims the benefit of U.S. Provisional Application No. 63/798,855, entitled “SELF-GENERATION OF FULL FUNCTION ESIM PROFILE,” filed May 2, 2025 and U.S. Provisional Application No. 63/722,736, entitled “SELF-GENERATION OF FULL FUNCTION ESIM PROFILE,” filed Nov. 20, 2024, the contents of all of which are incorporated by reference herein in their entirety for all purposes.

### FIELD

The described implementations set forth techniques for self-generation of a full function electronic subscriber identity module (eSIM) profile for a wireless device by merging dynamically-provisioned credentials into an eSIM template specific to a mobile network operator (MNO) or an MNO-agnostic eSIM template.

### BACKGROUND

Many wireless devices are configured to use removable universal integrated circuit cards (UICCs) that enable the wireless devices to access services provided by mobile network operators (MNOs). In particular, each UICC includes at least a microprocessor and a non-volatile memory (NVM). The NVM is configured to store a subscriber identity module (SIM) profile that the wireless device can use to register and interact with an MNO to obtain wireless services via a cellular wireless network. Typically, an UICC takes the form of a small removable card, commonly referred to as a SIM card, which is inserted into an UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIM (eSIM) profiles on the eUICC. The eSIM profiles can provide for new and/or different services and/or updates for accessing extended features provided by MNOs. An eUICC can store a number of eSIM profiles and can eliminate the need to include UICC-receiving bays in wireless devices.

A wireless device can include a bootstrap eSIM profile that provides a limited functionality connectivity option to allow the wireless device to connect to network servers for services such as for device activation, user eSIM installation, and the like. The bootstrap eSIM profile can be generated in the wireless device with limited options for customization from a generic eSIM profile installed at a time of manufacture. Full function eSIM profiles, typically, are downloaded from an MNO provisioning server to an eUICC of a wireless device. There exists a need for mechanisms to generate, at a wireless device, a full function eSIM profile for the wireless device to use to connect to a cellular wireless network of an MNO.

### SUMMARY

This application sets forth techniques for self-generation of a full function electronic subscriber identity module (eSIM) profile for a wireless device by merging dynamically-provisioned credentials into an eSIM template specific to a mobile network operator (MNO) or an MNO-agnostic eSIM template. When available locally on the wireless device, an MNO-specific eSIM template is selected and provided to an embedded universal integrated circuit card (eUICC) of the wireless device. Alternatively, when the MNO-specific eSIM template is not locally available on the wireless device, an MNO-agnostic eSIM template is selected and provided to the eUICC. The dynamically-provisioned credentials are merged with the selected eSIM template to cause the eUICC to create a full function eSIM profile for the wireless device. For example, the dynamically-provisioned credentials can be merged with the MNO-specific eSIM template to cause the eUICC to generate a customized eSIM profile for the wireless device to use to connect to a cellular wireless network of the MNO. As a further example, the dynamically-provisioned credentials can be merged with the MNO-agnostic eSIM template to cause the eUICC to generate a non-customized eSIM profile for the wireless device to use to connect to the cellular wireless network of the MNO.

In some implementations, the MNO-data includes a permanent international mobile subscriber identity (p-IMSI) value associated with the MNO that the wireless device receives from a provisioning server. The wireless device can connect to the provisioning server using an initial IMSI (i-IMSI) value as part of an internet protocol (IP), a non-access stratum (NAS) protocol, or a satellite protocol. The i-IMSI value can be arbitrarily selected from a group of i-IMSI values pre-installed in the eUICC during manufacturing. Alternatively, or in addition, the i-IMSI value can be a unique value that includes one or more identifiers of a particular MNO followed by a portion of an embedded identity document (EID) value. In some implementations, a set of digits for a unique subrange is included in the i-IMSI value between the identifiers of the MNO and the portion of the EID value.

In some implementations, the MNO-specific eSIM template includes a proprietary applet specific to the MNO, a proprietary authentication algorithm specific to the MNO, a public key specific to the MNO to use to generate a subscription concealed identifier (SUCI) for the wireless device, or a combination thereof. In some implementations, a plurality of MNO-specific eSIM templates can be loaded to the wireless device, e.g., during manufacturing. Each MNO-specific eSIM template can map to a specific MNO. In some implementations, the MNO-specific eSIM template is decrypted using a shared key specific to the MNO. In some implementations, the MNO-specific eSIM template can be obtained from an asset server after generation of the non-customized eSIM profile. In some implementations, the MNO-specific eSIM template obtained from the asset server is provided to the eUICC to cause the eUICC to create a customized eSIM profile for the wireless device by merging the MNO-specific eSIM template with the non-customized eSIM profile. In some implementations, the MNO-specific eSIM template obtained from the asset server includes one or more applets personalized for a subscriber, a mobile station international subscriber directory number (MSISDN) value, a new integrated circuit card identification (ICCID) value, or a combination thereof. In some implementations, a current ICCID value of the eSIM profile created using the MNO-agnostic eSIM template is replaced by a new ICCID value included in the MNO-specific eSIM template obtained from the asset server. In some implementations, the creation of the eSIM profile for the wireless device includes determining an ICCID value for the eSIM profile based on a p-IMSI value received from a provisioning server. In some implementations, instead of including the p-ISMI value, the ICCID value includes an encrypted value that is determined by encrypting the p-IMSI value using a shared key specific to the MNO.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 is a block diagram of different components of an exemplary system configured to implement the various techniques described herein, according to some implementations.

FIG. 2 is a block diagram of a more detailed view of an example of components of a mobile wireless device of the system of FIG. 1, according to some implementations.

FIG. 3 illustrates an example of a dynamic provisioning flow for a wireless device to obtain device specific data, according to some implementations.

FIG. 4 illustrates an example of an electronic subscriber identity module (eSIM) profile self-generation flow for a wireless device when a mobile network operator (MNO)-specific eSIM template is locally available on the wireless device, according to some implementations.

FIGS. 5A, 5B, and 5C illustrate an example of an eSIM profile self-generation flow for a wireless device when an MNO-specific eSIM template is locally available on the wireless device, according to some implementations.

FIG. 6 is a flow diagram of an example of a method for self-generation of a full function eSIM profile for a wireless device, according to some implementations.

FIG. 7 is a block diagram of different components of an exemplary system configured to implement the various techniques described herein, according to some implementations.

FIG. 8 is a block diagram of an example of a computing device, according to some implementations.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

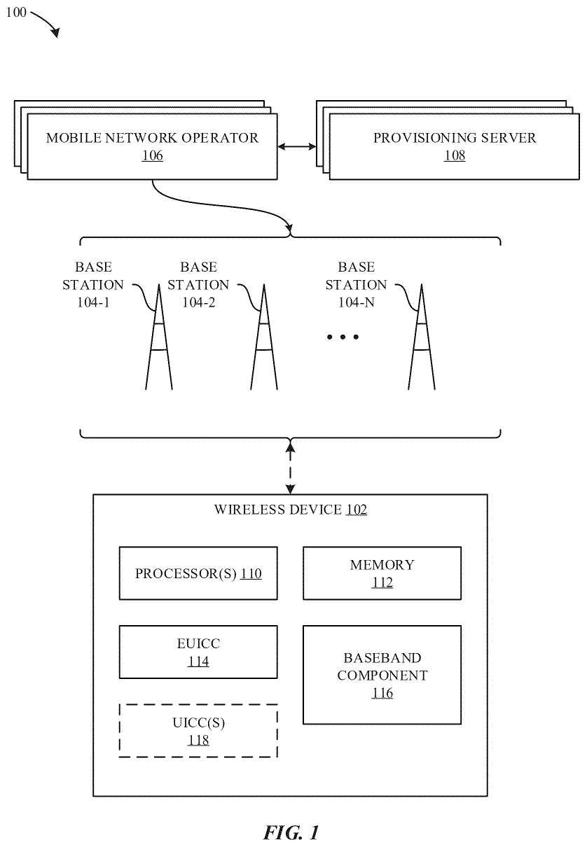

These and other implementations are discussed below with reference to FIGS. 1 through 8; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 104-1 to 104-N, which are managed by different mobile network operators (MNOs) 106, and iii) a set of provisioning servers 108 that are in communication with the MNOs 106. The wireless device 102 can represent a mobile computing device (e.g., a phone, a tablet, a peripheral device, etc.). The base stations 104-1 to 104-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 104-1 to 104-n can be a single entity, quasi-collocated entities, or separated among multiple units (e.g., central units (CUs), distributed units (DUs), remote units (RUs)). The MNOs 106 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more of the base stations 104-1 to 104-N.

As shown in FIG. 1, the wireless device 102 can include processing circuitry, which can include one or more processors 110 and a memory 112, an embedded universal integrated circuit card (eUICC 114), and a baseband component 116 used for transmission and reception of cellular wireless radio frequency signals. In some implementations, the wireless device 102 can include one or more universal integrated circuit cards (UICCs 118), also referred to as physical SIM cards, each of the UICCs 118 include a SIM, in addition to or in place of the eUICC 114 providing one or more electronic SIMs (eSIMs). A wireless device 102 that includes multiple active (enabled) SIMs and/or eSIMs can be referred to generally herein as a multi-SIM/eSIM wireless device. The one or more processors 110 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 112, processors 110, eUICC 114, baseband component 116, and UICC 118) can be arranged and combined in any number of configurations.

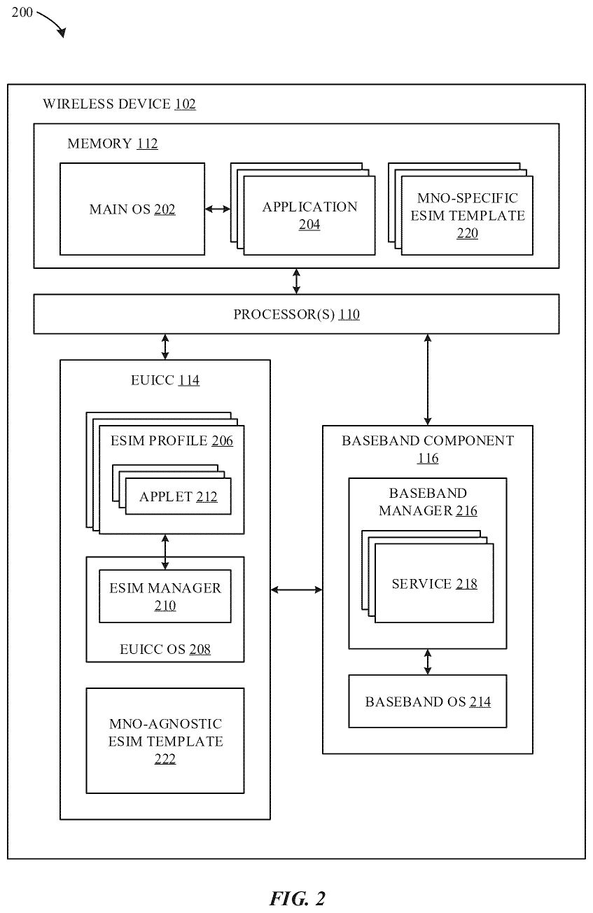

FIG. 2 is a block diagram of a more detailed view 200 of exemplary components of the wireless device 102 of FIG. 1. The one or more processors 110, in conjunction with the memory 112, can implement a main operating system (OS) 202 that is configured to execute applications 204 (e.g., native OS applications and user applications). The one or more processors 104 can include applications processing circuitry and, in some implementations, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 116, and other sensors (not shown) to determine states of components of the wireless device 102, e.g., reduced power modes, as well as of the wireless device 102 as a whole, e.g., mobility states, activity/inactivity states.

The eUICC 114 can be configured to store multiple eSIM profiles 206 for accessing cellular wireless services provided by different MNOs 106 by connecting to their respective cellular wireless networks through base stations 104-1 to 104-N. For example, the eUICC 114 can be configured to store and manage one or more eSIM profiles 206 for one or more MNOs 106 for different subscriptions to which the wireless device 102 is associated. To be able to access services provided by an MNO 106, an eSIM profile 206 can be reserved for subsequent download and installation to the eUICC 114. In some implementations, the eUICC 114 obtains one or more eSIM profiles 206 from one or more associated provisioning servers 108 as part of a device initialization of the wireless device 102, such as when purchasing a new wireless device 102. The provisioning servers 108 can be maintained by a manufacturer of the wireless device 102, the MNOs 106, third party entities, and the like. Communication of eSIM data between the provisioning server 108 and the eUICC 114 (or between the provisioning server 108 and processing circuitry of the wireless device 102, e.g., the processors 104) can use a secure communication channel. In some implementations, the processors 110 can be external to the eUICC 114. In some implementations, the eUICC 114 and the processors 110 and/or processing circuitry of the wireless device 102 can share processing resources.

The eUICC 114 can be configured to implement an eUICC OS 208 to manage the hardware resources of the eUICC 114 (e.g., a processor and a memory embedded in the eUICC 114). The eUICC OS 208 can also be configured to manage the eSIM profiles 206 that are stored by the eUICC 114, e.g., by enabling, disabling, modifying, updating, or otherwise performing management of the eSIM profiles 206 within the eUICC 114 and providing the baseband component 116 with access to the eSIM profiles 206 to provide access to wireless services for the wireless device 102. The eUICC OS 208 can include an eSIM manager 210, which can perform management functions for various eSIM profiles 206. Each eSIM profile 206 can include a number of applets 212 that define the manner in which the eSIM profile 206 operates. For example, one or more of the applets 212, when implemented by the baseband component 116 and the eUICC 114, can be configured to enable the wireless device 102 to communicate with an MNO 106 and provide useful features (e.g., phone calls and internet) to a user of the wireless device 102.

The baseband component 116 of the wireless device 102 can include a baseband OS 214 that is configured to manage hardware resources of the baseband component 116 (e.g., a processor, a memory, different radio components, etc.). The baseband component 116 (or a portion thereof) can also be referred to as a baseband component, a wireless baseband component, a baseband wireless processor, a cellular baseband component, a cellular component, and the like. According to some implementations, the baseband component 116 can implement a baseband manager 216 that is configured to interface with the eUICC 114 to establish a secure channel with a provisioning server 108 and obtain information (such as eSIM data) from the provisioning server 108 for purposes of managing eSIM profiles 206. The baseband manager 216 can be configured to implement services 218, which represent a collection of software modules that are instantiated by way of the various applets 212 of enabled eSIM profiles 206 that are instantiated in the eUICC 114. For example, services 218 can be configured to manage different connections between the wireless device 102 and MNOs 106 according to the different eSIM profiles 206 that are enabled within the eUICC 114. Further, one or more of the applets 212, when implemented in conjunction with the baseband component 116 and the eUICC 114, can be configured to enable the wireless device 102 to communicate with an MNO 106 and provide useful features (e.g., phone calls and internet access) to a user of the wireless device 102.

The memory 112 includes one or more MNO-specific eSIM templates 220 and associated rules loaded during manufacturing and/or added post-manufacturing. Each of the MNO-specific eSIM templates 220 is associated with a specific MNO 106. Each of the MNO-specific eSIM templates 220 can include an eSIM profile shell and static data specific to the MNO 106, e.g., one or more proprietary applets, executable code specific to the MNO 106, authentication algorithms and/or algorithm tunings preferred for use by the MNO 106, RiCi parameters, and/or one or more MNO public keys, such as a public key used for generating a specific subscription concealed identifier (SUCI) for the wireless device 102. Each of the MNO-specific eSIM templates 220 can include the MNO static data when stored on locally on the wireless device 102 (or when stored at a remote, network accessible server). Further, each of the MNO-specific eSIM templates 220 can be customized for the wireless device 102 with device specific data while the wireless device 102 is in the field. For example, each of the MNO-specific eSIM templates 220 can be later customized dynamically with device specific data obtained via a non-access stratum (NAS) authentication protocol. Exemplary device specific data includes a permanent international mobile subscriber identity (p-IMSI) value for a subscription and an associated authentication key Ki. By merging the device specific data for the wireless device 102 into an MNO-specific eSIM template 220, the eUICC 114 can generate a full function and customized eSIM profile 206 that the wireless device 102 can use to connect to a cellular wireless network of the MNO 106. For example, the wireless device 102 can activate a public data network (PDN) using the p-IMSI value and the associated authentication key Ki.

In some implementations, the processor 110 of the wireless device 102 can provide an MNO-specific eSIM template 220 to the eUICC 114, e.g., from the memory 112 or downloaded from a network accessible server. Exemplary network accessible servers can include MNO eSIM template asset servers and/or provisioning servers 108. In some implementations, an un-personalized eSIM template can be included in a bound profile package (BPP), and an identical eSIM template BPP, which is not personalized for a specific wireless device 102, can be downloaded to different wireless devices 102. The eSIM template included in the BPP can be specific to a particular MNO 106 but can be delivered in a generic, un-personalized form that is later customized for the particular wireless device 102. In some implementations, eSIM template BPPs can be downloaded, managed, and installed on an eUICC 114 of a wireless device 102 using processes similar to those used for eSIM profiles 206.

An eUICC manufacturer (EUM) can load an MNO-agnostic eSIM template 222 to the eUICC 114, e.g., as part of a manufacturing process for the eUICC 114. The MNO-agnostic eSIM template 222 is not associated with any specific MNO 106 and does not include any of the customizations that the MNO-specific eSIM templates 220 can include. For example, the MNO-agnostic eSIM template 222 does not include any of the static data specific to an MNO 106 described above. However, by merging the device specific data for the wireless device 102 into the MNO-agnostic eSIM template 222, the eUICC 114 can generate a full function and non-customized eSIM profile 206 that the wireless device 102 can use to connect to a cellular wireless network of the MNO 106.

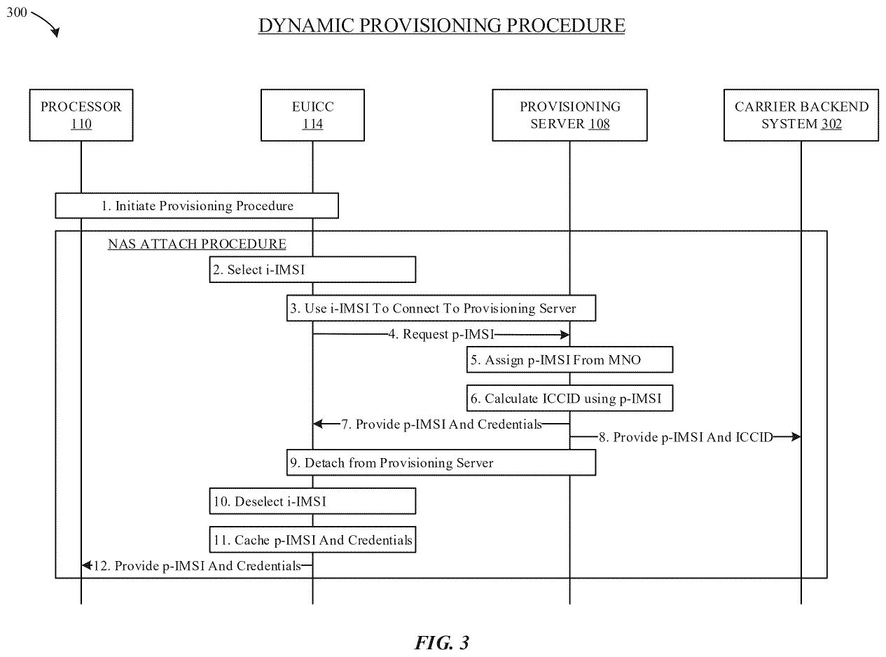

FIG. 3 illustrates a diagram 300 of an example of a dynamic provisioning flow for the wireless device 102 to obtain device specific data for the wireless device 102. The processor 110 of the wireless device 102 can initiate the provisioning procedure with the eUICC 114 of the wireless device 102. The eUICC 114 can select an initial IMSI (i-IMSI) value with which to obtain a server-assigned p-IMSI value. The eUICC 114 can select the i-IMSI value from a plurality of i-IMSI values pre-stored in the eUICC 114. The eUICC 114 can connect the wireless device 102 to the provisioning server 108 using the i-IMSI value and request a p-IMSI value. In some implementations, the request for a p-IMSI value can include one or more device identifiers for the wireless device 102. In some implementations, the eUICC 114 can perform a NAS attach procedure to receive the p-IMSI value from the provisioning server 108 using the selected i-IMSI value. In some implementations, the provisioning server 108 is maintained by an MNO 106 and is specific to the MNO 106. In other implementations, the provisioning server 108 is maintained by a third party, e.g., an OEM manufacturer or another service, and provides p-IMSI values for multiple MNOs 106. The provisioning server 108 can assign a p-IMSI value for the wireless device 102 applicable for use with a particular MNO 106. The p-IMSI value can include one or more identifiers of the particular MNO 106. For example, the first two to three digits of the p-IMSI value can be a mobile country code (MCC) value for an MNO 106 and the following two to three digits of the p-IMSI value can be a mobile network code (MNC) value for the MNO 106.

The provisioning server 108 can calculate an integrated circuit card identification (ICCID) value for the eUICC 114 using the p-IMSI value. The ICCID value identifies the specific eUICC 114. In some implementations, the ICCID value includes an 89 prefix, bits for the manufacturer of the eUICC 114 (e.g., three digits), the p-IMSI value, and a checksum value (e.g., one digit). In some implementations, instead of including the p-IMSI value, the ICCID value can include an encrypted value that is determined by encrypting the p-IMSI value using a shared key specific to the MNO 106.

The provisioning server 108 can provide the p-IMSI value and credentials to the eUICC 114 of the wireless device 102. In some implementations, the credentials include an authentication key Ki associated with the p-ISMI value, OPc parameters, a global identifier type 1 (GID1) value, a global identifier type 2 (GID2) value for a mobile virtual network operator (MVNO), or a combination thereof. The provisioning server 108 can also provide the p-IMSI value and/or the ICCID value to a carrier backend system 302 to indicate that these values have been provisioned. After receiving the p-IMSI value and the credentials, the eUICC 114 can detach the wireless device 102 from the provisioning server 108 and then deselect the i-IMSI value. The eUICC 114 can cache the p-IMSI value and the credentials and can provide the p-IMSI value and the credentials to the processor 110.

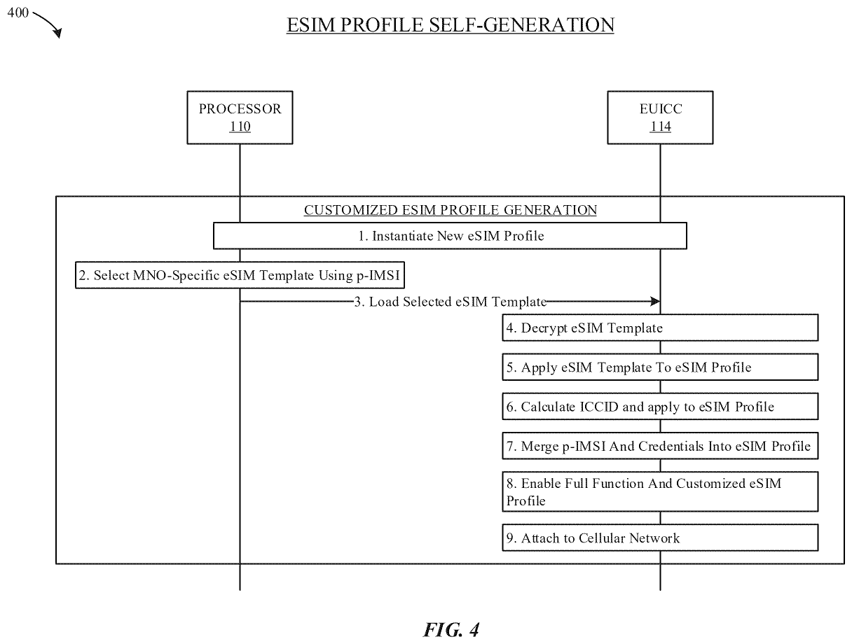

FIG. 4 illustrates a diagram 400 of an example of an eSIM profile self-generation flow for the wireless device 102 using an MNO-specific eSIM template 220 that is locally available on the wireless device 102. The processor 110 of the wireless device 102 can instantiate a new eSIM profile. The processor 110 can select an MNO-specific eSIM template 220 using the p-IMSI value that the wireless device 102 received via the dynamic provisioning flow described above in relation to FIG. 3. For example, the processor 110 can select an MNO-specific eSIM template 220 associated with the particular MNO 106 identified by the MCC value and/or the MNC value included in the prefix of p-IMSI value. In some implementations, selection of one of the MNO-specific eSIM templates 220 can further depend on a GID1 value and/or a GID2 value for an MVNO that the wireless device 102 may receive via the dynamic provisioning flow described above in relation to FIG. 3.

When the selected MNO-specific eSIM template 220 is available in local storage of the wireless device 102, the processor 110 can retrieve an eSIM template bundle (e.g., an eSIM template BPP) from local storage of the wireless device 102. After obtaining the eSIM template bundle/BPP from local storage, the processor 110 can provide the eSIM template bundle/BPP to the eUICC 114. In some implementations, the MNO-specific eSIM template 220 is encrypted. Thus, the eUICC 114 can decrypt the MNO-specific eSIM template 220 using a shared key specific to the MNO 106. For example, the eUICC 114 can retrieve a SCP03t session key from a personalization script that is pre-stored in the eUICC 114 after manufacturing of the wireless device 102. The eUICC 114 can apply the MNO-specific eSIM template to the newly-instantiated eSIM profile. Because the MNO-specific eSIM template 220 includes static data specific to the MNO 106, the newly-instantiated eSIM profile 206 is customized. The eUICC 114 an calculate the ICCID value and apply the ICCID value to the newly-instantiated eSIM profile 206. In addition, the eUICC 114 can merge the p-IMSI value and associated credentials into the newly-instantiated eSIM profile. In some implementations, the credentials associated with the p-IMSI value include an authentication key Ki associated with the p-ISMI value, a GID1 value, a GID2 value for an MVNO, or a combination thereof. Because the p-IMSI value is merged into the newly-instantiated eSIM profile 206, as opposed to merging some type of bootstrap IMSI, the newly-instantiated eSIM profile 206 has full function, i.e., the wireless device 102 can use the newly-instantiated eSIM profile 206 to connect to a cellular wireless network of the MNO 106 associated with p-IMSI value. After successful generation, the full function and customized eSIM profile 206 can be enabled. For example, the eUICC 114 can send to the processor 110 a refresh command, and the processor 110 can send a fetch command to the eUICC 114 to determine the updated state of the full function and customized eSIM profile 206. The full function and customized eSIM profile 206 is now available for the wireless device 102 to use to connect to a cellular wireless network of the MNO 106 associated with the p-IMSI value. For example, the wireless device 102 can activate a PDN using the p-IMSI value and the associated authentication key Ki.

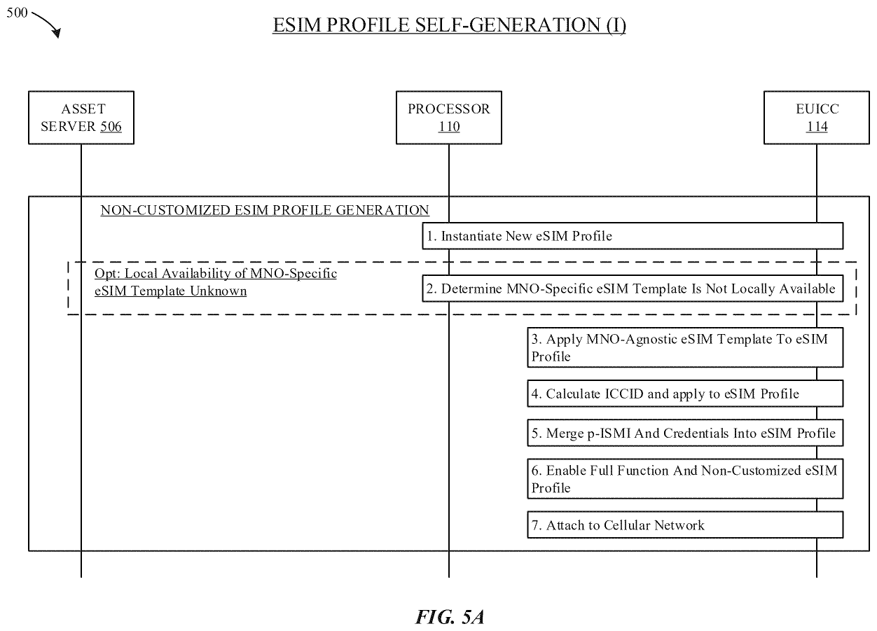

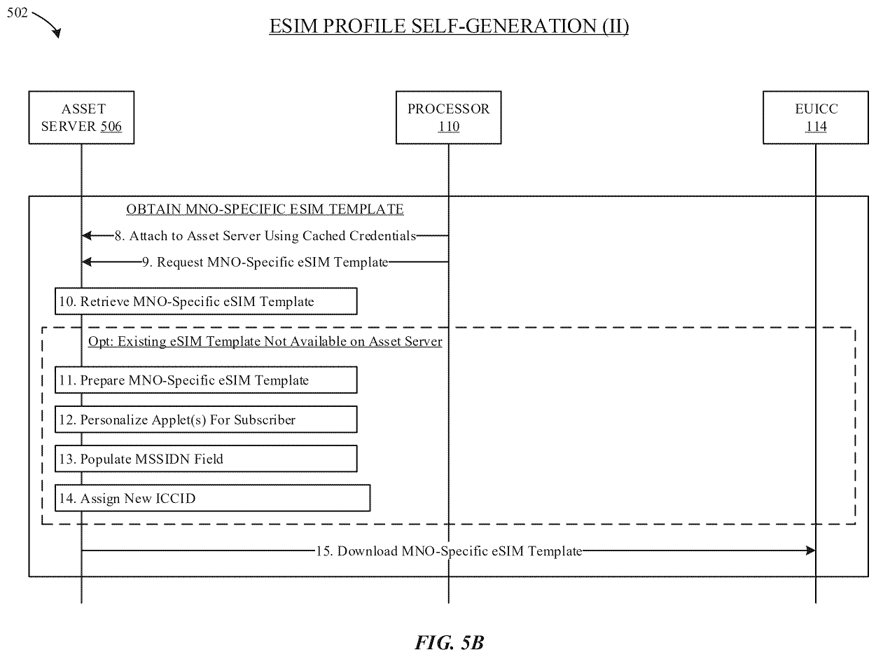

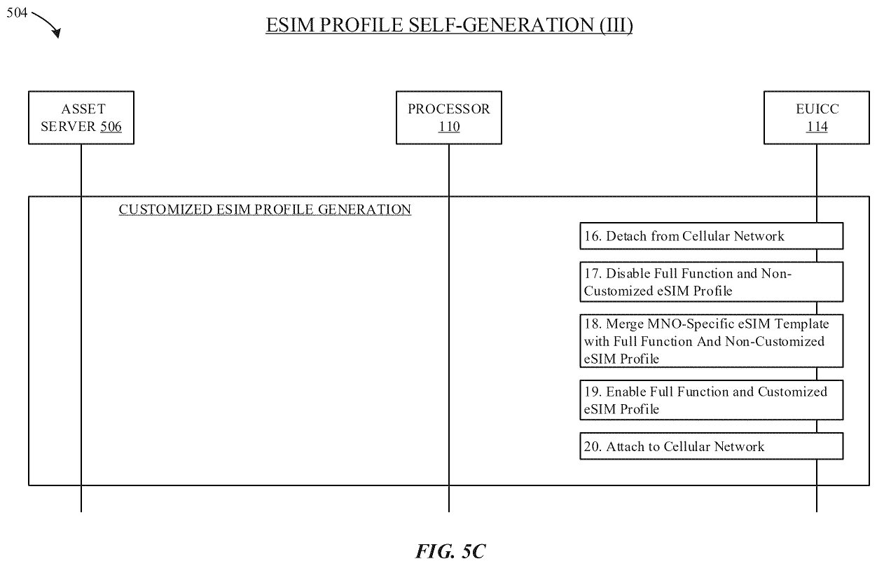

FIGS. 5A, 5B, and 5C illustrate diagrams 500, 502, 504 of an example of an eSIM profile self-generation flow for the wireless device 102 when an MNO-specific eSIM template 220 is not locally available on the wireless device 102. Starting with diagram 500 in FIG. 5A, the processor 110 of the wireless device 102 can instantiate a new eSIM profile. In some implementations, the local availability of an MNO-specific eSIM template 220 for the MNO 106 associated with the p-IMSI value is unknown. Thus, the processor 110 can determine that an MNO-specific eSIM template 220 for the MNO 106 associated with the p-IMSI value is not locally available on the wireless device 102. Because an MNO-specific eSIM template 220 for the MNO 106 associated with the p-IMSI value is not locally available on the wireless device 102, the processor 110 can select an MNO-agnostic eSIM template 222. The eUICC 114 can apply the MNO-agnostic eSIM template 222 to the newly-instantiated eSIM profile 206. Because the MNO-agnostic eSIM template 222 does not include static data specific to the MNO 106, the newly-instantiated eSIM profile 206 is non-customized. The eUICC 114 can calculate an ICCID value and apply the ICCID value to the newly-instantiated eSIM profile 206. In addition, the eUICC 114 can merge the p-IMSI value and associated credentials into the newly-instantiated eSIM profile 206. Because the p-IMSI value is merged into the newly-instantiated eSIM profile 206, as opposed to merging some type of bootstrap IMSI, the newly-instantiated eSIM profile 206 has full function, i.e., the wireless device 102 can use the newly-instantiated eSIM profile 206 to connect to a cellular wireless network of the MNO 106 associated with p-IMSI value. After successful generation, the full function and non-customized eSIM profile 206 can be enabled. For example, the eUICC 114 can send a refresh command to the processor 110, and the processor 110 can send a fetch command to the eUICC 114 to determine the updated state of the full function and non-customized eSIM profile 206. The full function and non-customized eSIM profile 206 is now available for the wireless device 102 to use to connect to a cellular wireless network of the MNO 106 associated with the p-IMSI value. For example, the wireless device 102 can activate a PDN using the p-IMSI value and the associated authentication key Ki.

Turning to diagram 502 in FIG. 5B, while using the full function and non-customized eSIM profile 206 to connect to a cellular wireless network of the MNO 106 associated with the p-IMSI value, the processor 110 of the wireless device 102 can obtain an MNO-specific eSIM template 220 from an asset server 506. The asset server 506 can be maintained by the MNO 106 associated with p-IMSI value or a third-party entity. The processor 110 can attach the wireless device 102 to the asset server 506 using cached credentials, e.g., the p-IMSI value and the associated credentials. The processor 104 can send a request message to the asset server 506 to obtain an MNO-specific eSIM templates 220 for the MNO 106 associated with the p-IMSI value that is available for downloading and installing to the eUICC 114. The request message can include identifier values for the MNO 106 (and optionally for an MVNO). In some implementations, the asset server 506 can retrieve an existing MNO-specific eSIM template 220 for the MNO 106 associated with the p-IMSI value. When an existing MNO-specific eSIM template 220 for the MNO 106 associated with the p-IMSI value is not available, the asset server 506 can assemble an MNO-specific eSIM template 220 for the MNO 106 associated with the p-IMSI value. In some implementations, the asset server 506 personalizes and adds one or more applets for a subscriber. In some implementations, the asset server 506 populates the mobile station international subscriber directory number (MSISDN) field in the MNO-specific eSIM template 220. The MSISDN value is a phone number that identifies a subscriber on a cellular network. In some implementations, the asset server 506 assigns and adds a new ICCID value to replace the existing ICCID value. The processor 110 and the eUICC 114 can communicate with the asset server 506 to download the MNO-specific eSIM template 220 in an eSIM template package or in an eSIM template BPP. In some implementations, the downloading and installation of the MNO-specific eSIM template 220 can use a standardized procedure for downloading and installing an eSIM template BPP.

Turning to diagram 504 in FIG. 5C, the eUICC 114 can detach the wireless device 102 from the cellular network and then disable the full function and non-customized eSIM profile 206. The eUICC 114 can merge the MNO-specific eSIM template 220 with the full function and non-customized eSIM profile 206 to create a full function and customized eSIM profile 206. After successful generation, the full function and customized eSIM profile 206 can be enabled. For example, the eUICC 114 can send a refresh command to the processor 110, and the processor 110 can send a fetch command to the eUICC 114 to determine the updated state of the full function and customized eSIM profile 206. The full function and customized eSIM profile 206 is now available for the wireless device 102 to use to connect to a cellular wireless network of the MNO 106 associated with the p-IMSI value. For example, the wireless device 102 can activate a PDN network using the p-IMSI value and the associated authentication key Ki.

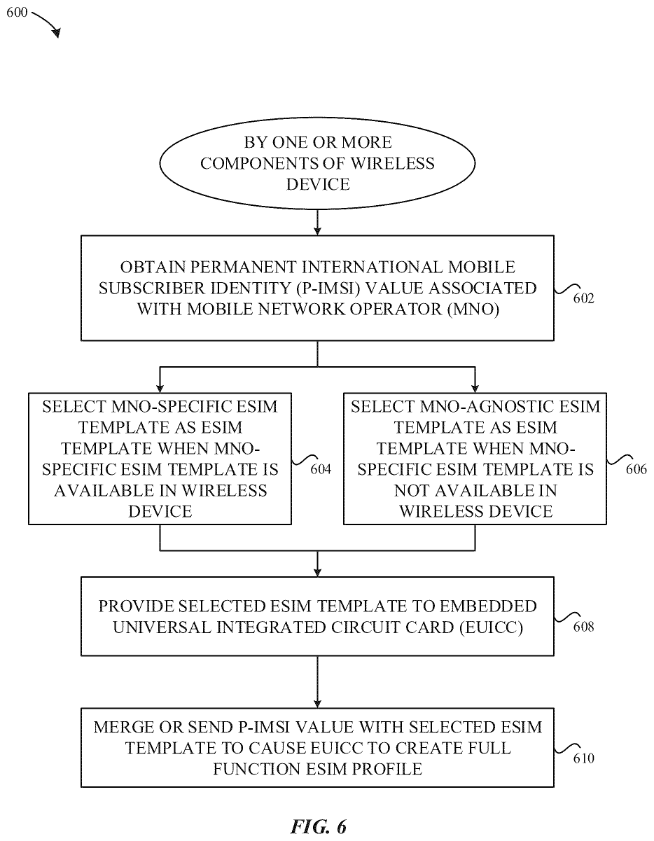

FIG. 6 is a flow diagram of an example of a method 600 for self-generation of a full function eSIM profile 206 for the wireless device 102. For simplicity of explanation, the method 600 is depicted in FIG. 6 and described as a series of operations. However, the operations can occur in various orders and/or concurrently, and/or with other operations not presented and described herein. At block 602, a p-IMSI value associated with the MNO 106 is obtained. In some embodiments, the p-IMSI value is received from a network server. For example, one or more components of the wireless device 102 (e.g., processors(s) 110, memory 112, baseband component 116, etc.) can initiate a dynamic provisioning procedure with the eUICC 114 of the wireless device 102 that causes the eUICC 114 to select an i-IMSI value with which to obtain a p-IMSI value, e.g., from a provisioning server 108. In some implementations, the eUICC 114 can perform a NAS attach procedure, using the selected i-IMSI value pre-stored in the eUICC 114, and request a p-IMSI value, e.g., from the provisioning server 108.

At block 604, an MNO-specific eSIM template 220 is selected as an eSIM template when the MNO-specific eSIM template 220 is available in the wireless device 102. For example, when a MNO-specific eSIM template 220 for the MNO 106 associated with the p-IMSI value is locally available in the wireless device 102, the MNO-specific eSIM template 220 may be selected. Alternatively, or in addition, at block 606, an MNO-agnostic eSIM template 222 is selected as the eSIM template when the MNO-specific eSIM template 220 is not available in the wireless device 102. For example, when the MNO-specific eSIM template 220 for the MNO 106 associated with the p-IMSI value is not locally available in the wireless device 102, an MNO-agnostic eSIM template 222 may be selected.

At block 608, the selected eSIM template is provided to an eUICC 114, e.g., to the eUICC 114 of the wireless device 102. In some implementations, one or more components of the wireless device 102 sends the selected eSIM template to the eUICC 114. For example, the processor 110 can retrieve an eSIM template bundle/BPP from local storage of the wireless device 102 and provide the eSIM template bundle/BPP to the eUICC 114. Alternatively, or in addition, the processor 110 sends a message to the eUICC 114 that directly identifies the selected eSIM template. For example, the processor 110 can send a message to the eUICC 114 that identifies the MNO-agnostic eSIM template 222 as the selected eSIM template. Alternatively, or in addition, the processor 110 sends a message to the eUICC 114 that indirectly identifies the selected eSIM template. For example, the processor 110 can send a message to the eUICC 114 that indicates an MNO-specific eSIM template 220 for the MNO 106 associated with the p-IMSI value is not locally available on the wireless device 102. Response to receiving the message, the eUICC 114 can determine that the MNO-agnostic eSIM template 222 is the selected eSIM template.

At block 610, the p-IMSI value is merged with the selected eSIM template (or sent with the selected eSIM template to the eUICC 114) to cause the eUICC 114 to create the full function eSIM profile 206. In some implementations, the eUICC 114 can merge the p-IMSI value and the associated credentials with the selected eSIM template. The credentials associated with p-IMSI value can include an authentication key Ki associated with the p-ISMI value, a GID1 value, a GID2 value for an MVNO, or a combination thereof. In some implementations, the eUICC 114 further creates the full function eSIM profile 206 by determining an ICCID value for the eSIM profile 206 based on the p-IMSI value. In some implementations, the wireless device 102 connects to a cellular network of the MNO 106 using the eSIM profile 206. For example, the wireless device 102 can activate a PDN using the p-IMSI value and the associated credentials.

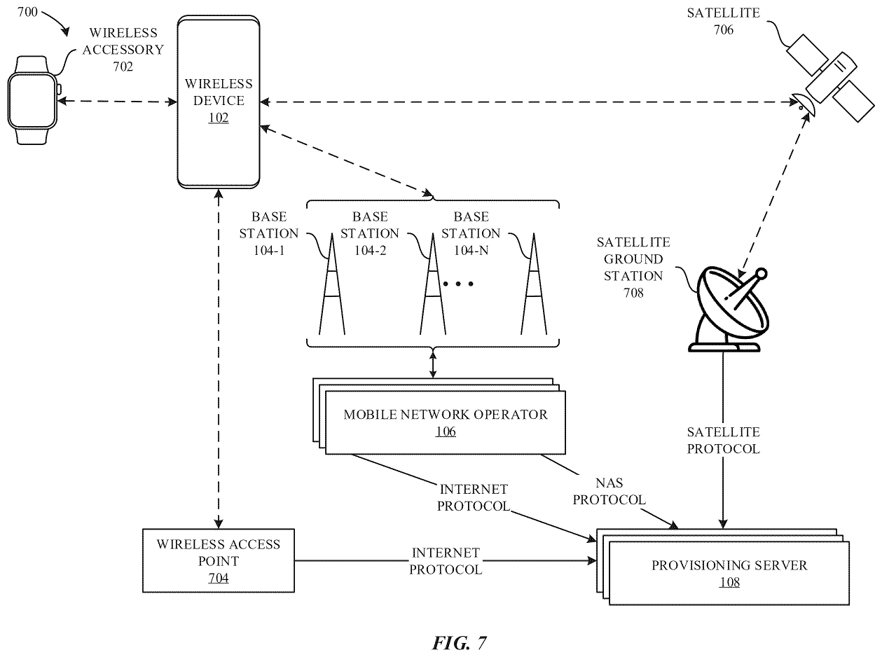

FIG. 7 is block diagram of an example of a system 700 that includes i) a wireless device 102, ii) base stations 104-1 to 104-N, iii) MNOs 106, iv) provisioning servers 108, v) a wireless accessory 702, vi) a wireless access point 704, vii) a satellite 706, and viii) a satellite ground station 708. The provisioning servers 108 are in communication with the MNOs 106, the wireless access point 704, and the satellite ground station 708. The wireless accessory 702 is illustrated in FIG. 7 as a smartwatch but can also represent other wireless accessories such as wireless earbuds, smart glasses, wearable fitness trackers, etc. The wireless accessory 702 may include components similar to the ones described herein as being included in the wireless device 102. In FIG. 7, the wireless accessory 702 wirelessly communicates with the wireless device 102 (e.g., using Bluetooth™). In some implementations, the wireless accessory 702 wirelessly communicates with the wireless access point 704 (e.g., using Wi-Fi). Further, the wireless accessory 702 can wirelessly communicate with a base station 104 using a cellular connection. The wireless access point 704 can provide one of more Wi-Fi connections. The wireless access point 704 be included in a wireless router, a cable modem, an enterprise network, etc.

The eUICC 114 of the wireless device 102 can use a NAS protocol (e.g., a NAS attach procedure) or an internet protocol to receive a p-IMSI value from the provisioning server 108 via a base station 104 and an MNO 106. The eUICC 114 can also use an internet protocol to receive the p-IMSI value from the provisioning server 108 via the wireless access point 704. Further, the eUICC 114 can also use a satellite protocol to receive the p-IMSI value from the provisioning server 108 via the satellite 706 and the satellite ground station 708.

As described above, the eUICC 114 can select an i-IMSI value and connect the wireless device 102 to the provisioning server 108 using the i-IMSI value in order to request a p-IMSI value. In some implementations, the eUICC 114 can arbitrarily select the i-IMSI value from a plurality of i-IMSI values pre-stored in the eUICC 114. However, the use of a random i-IMSI value leads to a risk of collision. For example, a collision may occur if more than one device randomly selects the same i-IMSI value out of the same pool at the same time. Thus, to avoid collision, the eUICC 114 can select a unique i-IMSI value based on one or more identifiers associated with one or more components of the wireless device 102 and/or a particular MNO 106. In some implementations, the i-IMSI value can include one or more identifiers of a particular MNO 106 followed by a portion of an embedded identity document (EID) value. For example, the most significant five to six digits of the i-IMSI value can be a three digit MCC value followed by a two to three digit MNC value for an MNO 106. The EID value is a thirty-two digit unique identification number assigned to the UICC 118 in the wireless device 102, e.g., during manufacturing. A portion of the EID value can be included at the end of the i-IMSI value. In some implementations, a sequential and unique portion of the EID value is included at the end of the i-IMSI value. For example, the i-IMSI value can include the last five digits of the serial/random portion of the EID (i.e., digits 26 to 30 of the EID).

In some implementations, a set of digits for a unique subrange is included in the i-IMSI value between the identifiers of the MNO 106 and the portion of the EID value. For example, the i-IMSI value can include four digits for a unique routing identifier associated with the MCC/MNC. In some situations, the i-IMSI value does not need to include the unique subrange to avoid collision. For example, routing is performed to a dedicated endpoint when connecting to the provisioning server 108 using an internet protocol or a satellite protocol. Thus, the unique subrange can be omitted from the i-IMSI value when an internet protocol or a satellite protocol is used to receive the p-IMSI value from the provisioning server 108. As a further example, the unique subrange can be omitted from the i-IMSI value when the MCC/MNC is unique or dedicated to routing signaling over a cellular network via the NAS attach procedure.

In some implementations, the length of the i-IMSI value is selected based on the type of protocol used to connect to the provisioning server 108. For example, the i-IMSI value can be any length when an internet protocol is used to receive the p-IMSI value from the provisioning server 108 because routing is fixed over internet protocol. As a further example, to comply with the 3^{rd} generation partnership project (3GPP) specification, the i-IMSI value can be fifteen digits when a satellite protocol is used to receive the p-IMSI value from the provisioning server 108.

### Representative Exemplary Apparatus

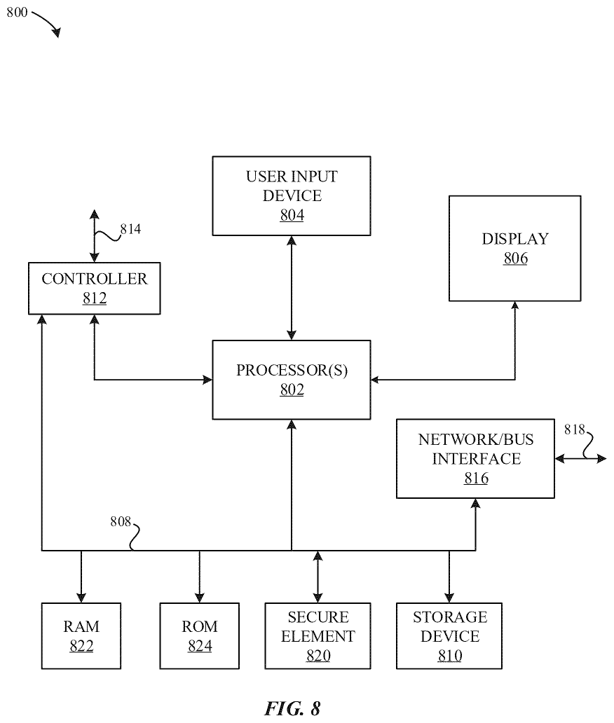

FIG. 8 is a block diagram of an example of a computing device 800 that can be used to implement the various components and techniques described herein, according to some implementations. In particular, the detailed view of the computing device 800 illustrates various components that can be included in the wireless device 102. As shown in FIG. 8, the computing device 800 can include one or more processors 802 that represent microprocessors or controllers for controlling the overall operation of the computing device 800. In some implementations, the computing device 800 can also include a user input device 804 that allows a user of the computing device 800 to interact with the computing device 800. For example, in some implementations, the user input device 804 can take a variety of forms, such as a button, keypad, dial, touch screen, audio input interface, visual/image capture input interface, input in the form of sensor data, etc. In some implementations, the computing device 800 can include a display 806 (screen display) that can be controlled by the processor(s) 802 to display information to the user (for example, information relating to incoming, outgoing, or active communication sessions). A data bus 808 can facilitate data transfer between at least the processor(s) 802, a storage device 810, and a controller 812. The controller 812 can be used to interface with and control different equipment through an equipment control bus 814. The computing device 800 can also include a network/bus interface 816 that couples to a data link 818. In the case of a wireless connection, the network/bus interface 816 can include wireless circuitry, such as a wireless transceiver and/or baseband component. The computing device 800 can also include a secure element 820. The secure element 820 can include the eUICC 114 and/or one or more UICCs 118.

The storage device 810 can include a single disk or a plurality of disks (e.g., hard drives and/or solid-state drives), and includes a storage management module that manages one or more partitions within the storage device 810. In some implementations, the storage device 810 can include flash memory, semiconductor (solid state) memory or the like. The computing device 800 can also include a Random Access Memory (RAM) 822 and a Read-Only Memory (ROM) 824. The RAM 822 can provide volatile data storage, and stores instructions related to the operation of the computing device 800. The ROM 824 can store programs, utilities or processes to be executed in a non-volatile manner.

### Wireless Terminology

In accordance with various implementations described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various implementations of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN), a wireless local area network (WLAN), a wireless personal area network (WPAN), a near field communication (NFC), a cellular wireless network, a fourth generation (4G) Long Term Evolution (LTE), LTE Advanced (LTE-A), 5G, and/or 6G, or other present or future developed advanced cellular wireless networks.

The wireless communication device, in some implementations, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some implementations, the client device can be any wireless communication device that is capable of communicating via a WLAN technology, e.g., in accordance with a wireless local area network communication protocol. In some implementations, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode UE can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE or a 3G legacy network, e.g., an Evolved High-Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for self-generation of a full function electronic subscriber identity module (eSIM) profile for a wireless device, the method comprising:
by one or more components of the wireless device:
obtaining a permanent international mobile subscriber identity (p-IMSI) value associated with a mobile network operator (MNO);
selecting:
an MNO-specific eSIM template as an eSIM template when the MNO-specific eSIM template is available in the wireless device, or
an MNO-agnostic eSIM template as the eSIM template when the MNO-specific eSIM template is not available in the wireless device;
providing the selected eSIM template to an embedded universal integrated circuit card (eUICC); and
merging or sending the p-IMSI value with the selected eSIM template to cause the eUICC to create the full function eSIM profile.

2. The method of claim 1, wherein selection of the MNO-specific eSIM template as the selected eSIM template further comprises:
selecting, based on at least a portion of the p-IMSI value, the MNO-specific eSIM template from a plurality of eSIM templates stored in the wireless device, and
wherein each of the plurality of eSIM templates maps to a specific MNO.

3. The method of claim 1, wherein:
the selected eSIM template comprises the MNO-specific eSIM template; and the method further comprises:
providing the MNO-specific eSIM template to the eUICC causes the eUICC to decrypt the MNO-specific eSIM template using a shared key specific to the MNO.

4. The method of claim 1, wherein
the full function eSIM profile comprises a full function and non-customized eSIM profile, and
the method further comprises:
sending a request that causes an asset server to provide the MNO-specific eSIM template to the eUICC to cause the eUICC to create a full function and customized eSIM profile by merging the MNO-specific eSIM template with the full function and non-customized eSIM profile.

5. The method of claim 4, wherein:
the full function and non-customized eSIM profile includes a first integrated circuit card identification (ICCID) value;
the MNO-specific eSIM template includes a second ICCID value; and
the one or more components of the wireless device provide the MNO-specific eSIM template to the eUICC to cause the eUICC to merge the MNO-specific eSIM template with the full function and non-customized eSIM profile by replacing the first ICCID value with the second ICCID value.

6. The method of claim 1, wherein creation of the full function eSIM profile further comprising determining an integrated circuit card identification (ICCID) value for the full function eSIM profile based on the p-IMSI value.

7. The method of claim 6, wherein:
determination of the ICCID value for the full function eSIM profile based on the p-IMSI value further comprises determining an encrypted value by encrypting the p-IMSI value using a shared key specific to the MNO, and
the encrypted value is included in the ICCID value.

8. The method of claim 1, further comprising connecting the wireless device to a cellular network of the MNO using the full function eSIM profile.

9. The method of claim 1, wherein the obtaining p-IMSI value further comprises:
selecting an initial IMSI (i-IMSI) value,
connecting to a network server using the i-IMSI value, and
sending a request that causes the network server to provide the p-IMSI value to the wireless device.

10. The method of claim 9, wherein the i-IMSI value includes at least one of:
one or more identifiers associated with the MNO,
a unique subrange, and/or
a portion of an embedded identity document (EID) value associated with a universal integrated circuit card (UICC).

11. The method of claim 9, wherein connecting the wireless device to the network server using the i-IMSI value further comprises connecting the wireless device to the network server using the i-IMSI value and based on at least one of an internet protocol (IP), a non-access stratum (NAS) protocol, and/or a satellite protocol.

12. An apparatus comprising memory coupled to processing circuitry, the processing circuitry configured to:
obtain a permanent international mobile subscriber identity (p-IMSI) value associated with a mobile network operator (MNO);
select:
an MNO-specific electronic subscriber identity module (eSIM) template as an eSIM template when the MNO-specific eSIM template is available in the memory; or
an MNO-agnostic eSIM template as the eSIM template when the MNO-specific eSIM template is not available in the memory;
provide the selected eSIM template to an embedded universal integrated circuit card (eUICC); and
merge or send the p-IMSI value with the selected eSIM template to cause the eUICC to create a full function eSIM profile.

13. The apparatus of claim 12, wherein, to select the MNO-specific eSIM template as the selected eSIM template, the processing circuitry is further configured to select, based on at least a portion of the p-IMSI value, the MNO-specific eSIM template from a plurality of eSIM templates stored in the memory, and
wherein each of the plurality of eSIM templates maps to a specific MNO.

14. The apparatus of claim 12, wherein:
the selected eSIM template comprises the MNO-specific eSIM template; and
provision of the MNO-specific eSIM template to the eUICC causes the eUICC to decrypt the MNO-specific eSIM template using a shared key specific to the MNO.

15. The apparatus of claim 12, wherein
the full function eSIM profile comprises a full function and non-customized eSIM profile, and
the processing circuitry is further configured to send a request that causes an asset server to provide the MNO-specific eSIM template to the eUICC to cause the eUICC to create a full function and customized eSIM profile by merging the MNO-specific eSIM template with the full function and non-customized eSIM profile.

16. The apparatus of claim 15, wherein:
the full function and non-customized eSIM profile includes a first integrated circuit card identification (ICCID) value,
the MNO-specific eSIM template includes a second ICCID value, and
the processing circuitry is further configured to provide the MNO-specific eSIM template to the eUICC to cause the eUICC to merge the MNO-specific eSIM template with the full function and non-customized eSIM profile by replacing the first ICCID value with the second ICCID value.

17. The apparatus of claim 15, wherein the MNO-specific eSIM template includes one or more of:
one or more applets personalized to a subscriber;
a mobile station international subscriber directory number (MSISDN) value;
a proprietary applet specific to the MNO;
a proprietary authentication algorithm specific to the MNO; or
a shared key specific to the MNO to use to generate a subscription concealed identifier for the apparatus.

18. The apparatus of claim 12, wherein the processing circuitry is further configured to receive the p-IMSI value from the network server as part of a non-access stratum attach procedure that uses an initial IMSI value pre-installed in the eUICC during manufacturing.

19. The apparatus of claim 12, wherein the processing circuitry is further configured to:
select an initial IMSI (i-IMSI) value;
connect to a network server using the i-IMSI value; and
send a request that causes the network server to provide the p-IMSI value to the apparatus,
wherein the i-IMSI value includes at least one of:
one or more identifiers associated with the MNO,
a unique subrange, and/or
a portion of an embedded identity document (EID) value associated with a universal integrated circuit card (UICC).

20. A non-transitory computer-readable storage medium storing instructions to configure one or more components of a wireless device to:
obtain a permanent international mobile subscriber identity (p-IMSI) value associated with a mobile network operator (MNO);
select:
an MNO-specific electronic subscriber identity module (eSIM) template as an eSIM template when the MNO-specific eSIM template is available in the wireless device; or
an MNO-agnostic eSIM template as the eSIM template when the MNO-specific eSIM template is not available in the wireless device;
provide the selected eSIM template to an embedded universal integrated circuit card (eUICC); and
merge or send the p-IMSI value with the selected eSIM template to cause the eUICC to create a full function eSIM profile.
